(19) United States
(12) Patent Application Publication
(10) Pub. No.: US 2005/0081424 A1
(43) Pub. Date: Apr. 21, 2005

(54) Effervescent fish bait

(76) Inventor: Jerome Glasser, Maplewood, NJ (US)

Correspondence Address: JEROME GLASSER, 16 SUNSET TERRACE, MAPLEWOOD, NJ, 07040, US

(21) Appl. No.: 10/965,116

(22) Filed: Oct. 14, 2004

Related U.S. Application Data
(60) Provisional application No. 60/511,014, filed on Oct. 14, 2003.

(51) Int. Cl. A01K 85/00; A01K 91/00

(52) U.S. Cl. 43/42.22; 424/84

(57) ABSTRACT

Fish halt or lure incorporates a gas into a cooled, hot melt solid gasified matrix which, when placed in contact with water, gradually dissolves in a continuous manner thereby releasing its gas bubbles and causing an effervescent action which serves to attract fish.

### CROSS-REFERENCE TO RELATED APPLICATION

This U.S. Patent Application claims priority to U.S. Provisional Patent Application No. 60/511,014 filed Oct. 14, 2003.

### FIELD OF THE DISCLOSURE

The present disclosure relates to fish bait and fishing lures.

### BACKGROUND OF THE DISCLOSURE

Fish bait is well known in the prior art. What is entirely new and novel within the fish bait sphere is disclosed herein as a water-soluble, cooled, hot melt solid matrix having carbonation mixed, essentially, entirely thoughout it. The effect of the solid, gas-containing matrix is such that when it comes in contact with water, the solid dissolves, thereby freeing the previously trapped gas bubbles from the solid matrix. The effervescent action of this release causes a disturbance in the water which attracts fish and potentially other sea creatures to the area in which a fish hook or other trapping or snaring means, such as a net, may allow for their being caught.

While live worms may be employed in combination with the new and novel fish bait of this disclosure, the addition of an essential oil which mimics the chemical profile transmitted to fish by the natural worm upon its placement into water can serve to obviate the need to deplete the worm population, thereby aiding in the preservation of the worm as a valued species on our planet.

### SUMMARY AND OBJECTS OF THE DISCLOSURE

The present disclosure reveals an effervescent fish bait and system which includes a gasified solid matrix which melts in contact with water thereupon releasing the gas impregnated within the solid matrix. It is possible to use this apparatus in combination with traditional fish-catching gear such as nets and fish hooks.

One object of this disclosure is to produce an inexpensive, yet superlative fish bait device and method of its use, having the capacity to attract the interest of fish and/or other swimming creatures, which can aid, primarily but not exclusively, a person fishing in his or her attempt to attract and catch significant numbers of fish.

Yet another object of this disclosure is to contribute towards efforts to preserve the world's worm population. Worms are unconditionally reviled the world over. Few cultures champion the cause of the lowly worm, a creature which is potentially destined for extinction as a result of the zealous and growing fishing habits of humans, particularly humans in North America.

### BRIEF DESCRIPTION OF THE DRAWINGS

FIG. 1. is a frontal perspective view of a solid matrix having a metal or plastic loop-type attachment embedded into its upper area so that it may be threaded with fishing line.

FIG. 2. is a frontal perspective view of a solid matrix having holes through which fishing line may be threaded.

FIG. 3 is a perspective view of a cylindrical, tubular rod-like element having a hole therethrough so that a fishing or netting line may be passed through.

FIG. 4 is a perspective view of particles of broken pieces of gasified “pebbles” stuck together to form a shape and having a peel-away, water-insoluble glue.

FIG. 5 is a perspective view of a ball-shape having a channel-ridge to accommodate the tether-line around its body.

FIG. 6 is a frontal view of a mesh-type bag or net holding gas-impregnated pieces.

FIG. 7 is a frontal view of a net, such as a commercial fishing net, having multiple FIG. 3 elements attached.

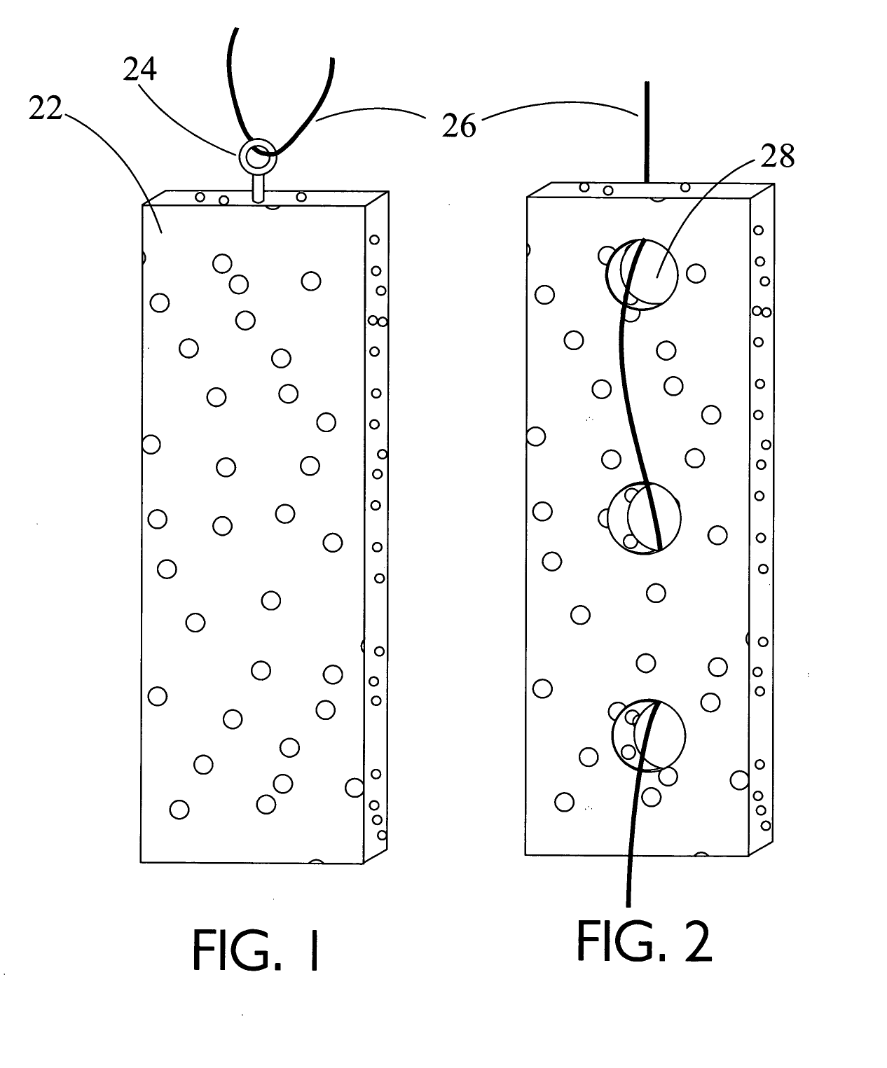

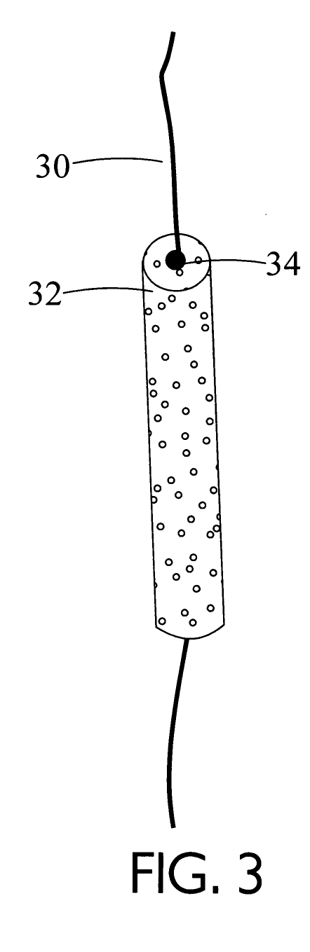

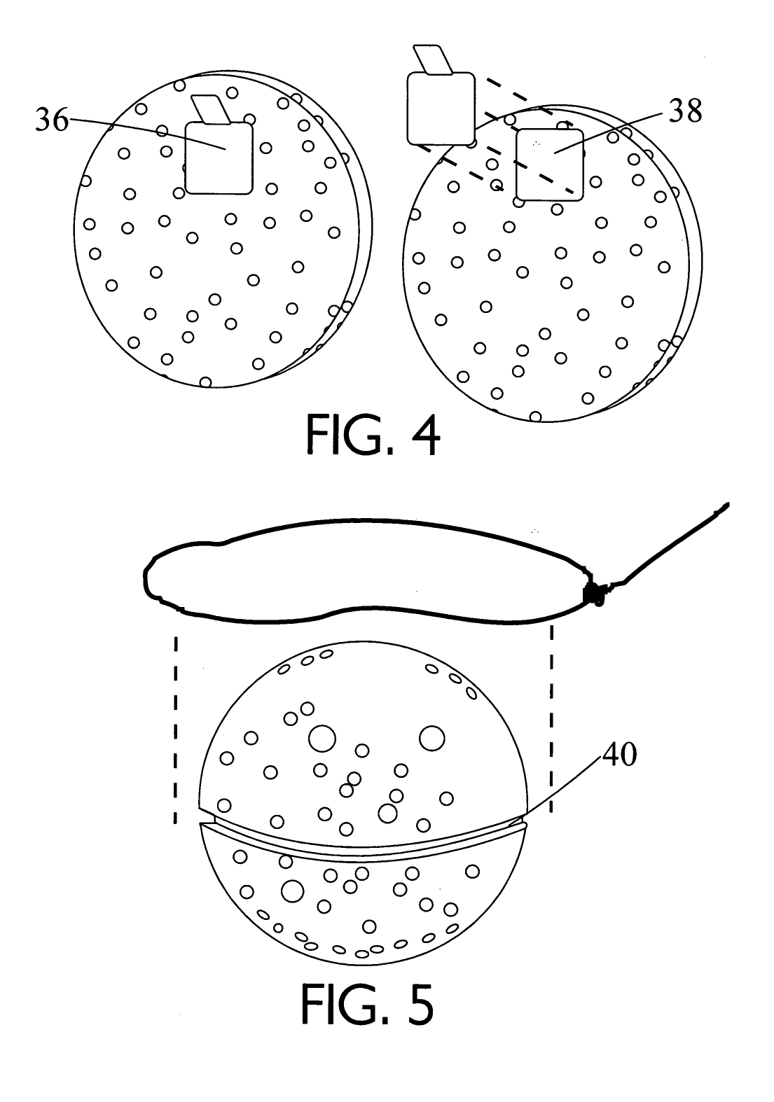

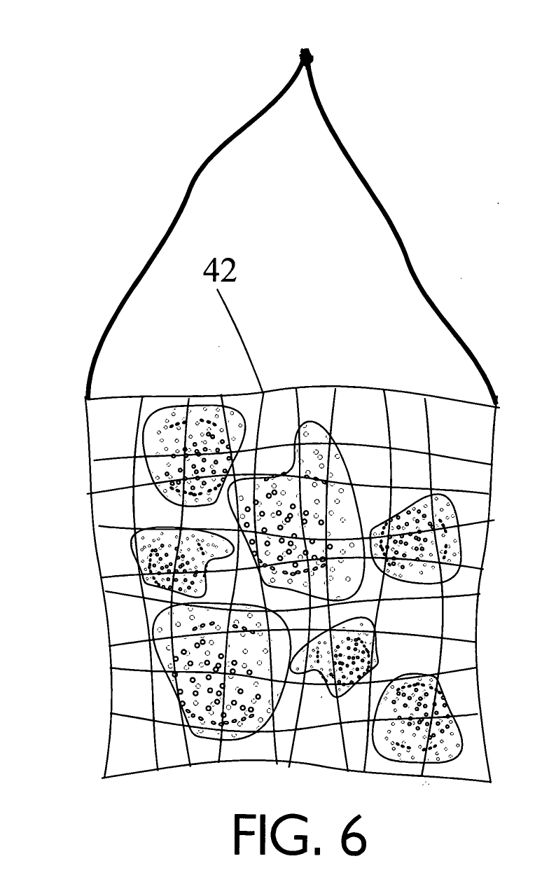

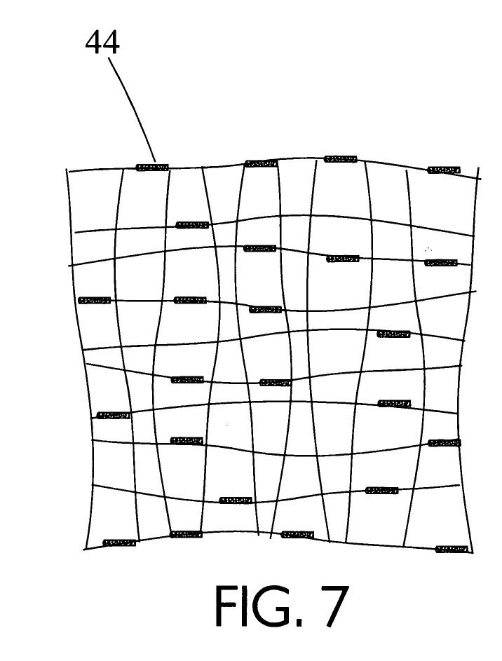

22 Matrix Body
24 Eye Loop
26 Fishing Line
28 Thread Hole
30 Fishing Line Attachment Line
34 Bore Hole
36 Peel-Away Cover Tab
38 Adhesive
40 Channel-Ridge
42 Mesh Bag
44 Tubular Matrix Body

### DESCRIPTION OF AN EMBODIMENT

In an embodiment of this disclosure, a carbonated solid matrix is gasified in a similar manner to that disclosed by U.S. Pat. No. 4,001,457 to Hegadom, Issued Jan. 4, 1977. The product derived from this process, Matrix Body 22, may be in shaped form, such as a relatively flat, traditional chocolate bar-like element having either an attached Eye Loop 24, integrally molded into Matrix Body 22, or glued onto or screwed into Matrix Body 22, or Thread Holes 28 through which Fishing Line 26 may be threaded and/or temporarily or permanently moveably or immoveably set. This device may be used by itself, by being either dipped alone into water as part of an effort to attract fish, or as part of a system in conjunction with fishing devices and/or accoutrements, such as a sinker and a fishing hook. The effervescent action attracts fish which, upon curiously investigating the disturbance in the water caused by the gas bubbles escaping from the solid matrix, and in hopeful anticipation of breakfast, lunch or dinner, depending on the time of day, may be scooped with a net, or reeled in when used in conjunction with a proximate fish hook. If a fish bites on a coordinating fishing hook, it—itself—winds up becoming breakfast, lunch or dinner. When the water-soluble, gasified solid matrix is attached or placed in close proximity to a fishhook on a rod and reel system, it becomes be an effective device for attracting fish and other sea creatures in the sport of fishing.

In the absence of a “current” or significant waves, the device of this disclosure may be used in a manner in which it is untethered to a fishing line. Multiple means exist and are known to one skilled in the art, relating to tethering fishing accoutrements, accessories and fishing aids to fishing lines having hooks on the end dipped into the water. Channel-Ridge 40 discloses one method of enhanced tethering by creating an indentation channel out of which Fishing Line 26 should not easily slip if wound tightly enough with slip-resistant line.

A Bore Hole 34 which may be drilled entirely throughout an elongated Matrix Body 22, thereby permitting the introduction therethrough of a Fishing Line Attachment Line 30 which may be of a thin metal or string or some form of plastic-like thread or line. Such a configuration permits the bait device to be slidably disposed either along Fishing Line Attachment Line 30, or along Fishing Line 26.

A Matrix Body 22 which is spherical or flat and circular, although the actual shape should not be constrained to that indicated in this description, but rather, limited in scope exclusively by the parameters delineated by the claims, may have an Adhesive 38 section covered with a Peel-Away Cover Tab 36, which, when Peel-Away Cover Tab 36 is removed, provide the opportunity for Matrix Body 22 to be attached, potentially removeably, depending on the strength used in Adhesive 38, to a fishing line, hook or other accoutrements.

A Mesh Bag 42 may be employed to hold individual, pebble- or M & M-resembling pieces of Matrix Body 22.

Tubular Matrix Body 44 may be strung along commercial or smaller-scale tourist fishing nets and may even be useful for signaling distress or danger to scuba divers.

When a synthetic chemical mimicking the natural chemical formulation exuded through the water by a live worm when placed into the water, is introduced into the production of a Matrix Body 22, it can further serve as a means to attract fish.

The use of a cyallume, chemical light stick may, further, enhance the chances to attract fish in coordination with the device of this disclosure by offering yet another, visual stimulation.

This disclosure is novel. While preferred embodiments of the present disclosure have been described and illustrated using specific terms, such description is for illustrative purposes only. It may be appreciated and understood that changes and modification of the disclosure as described herein may be made by a person skilled in the art to which this subject matter pertains without substantially deviating from the spirit and scope of the disclosure and of the following claims. As the embodiments presented are capable of variation, addition, omission and modification without departing from the spirit and scope of the disclosure, consequently, it is not the intention of the applicant to limit the scope of this disclosure exclusively to those modes and embodiments of the disclosure shown or described above. Protection is desired for all changes and modifications that come within the spirit of the disclosure.

1. Effervescent fish bait comprising:
a. obtaining a hot melt,
b. introducing the hot melt into a first pressure vessel,
c. introducing a gas at superatmospheric pressure into the first pressure vessel so that the gas is dispersed within the hot melt,
d. introducing a gas at superatmospheric pressure into a second pressure vessel which has polished inner surfaces at a value equivalent to the pressure within the first pressure vessel, the first and second pressure vessels having a connecting line with valve means between the first vessel and the bottom of the second vessel,
e. transferring the gasified hot melt to the second pressure vessel through the connecting line by opening said valve means and then creating a pressure differential between the two vessels, said differential being effected by regulating the superatmospheric pressure in the second pressure vessel at a value lower than the superatmospheric pressure in the first pressure vessel and venting the top of the second pressure vessel,
f. isolating the second pressure vessel while continuing to maintain a superatmospheric pressure,
g. cooling the second pressure vessel so that the gasified hot melt becomes a gas-containing solid matrix,
h. venting the second pressure vessel which causes the matrix to shatter into multiple fragments, and
i. opening the second pressure vessel to allow the product to be removed;
j. the placement of said product in water in which marine life is believed to exist for the purpose of attracting said marine life, typically, for capture.

2. The effervescent fish bait of claim. 1, wherein
the gas is carbon dioxide.

3. The The effervescent fish bait of claim 2, wherein:
the gas is carbon dioxide;
the superatmospheric pressure is maintained between 50 p.s.i. and 1000 p.s.i.

4. The effervescent fish bait of claim 3, wherein:
the pressure differential maintained during transfer is 5 p.s.i. to 150 p.s.i.;
the shock treatment of the second pressure vessel is effective to shatter the gas-containing solid matrix into separate pieces.

5. The effervescent fish bait of claim 4, wherein:
the second pressure vessel is vented to atmosphere through means which permit precise control over the exiting gas.
